(19) United States
(12) Patent Application Publication
(10) Pub. No.: US 2006/0224488 A1
(43) Pub. Date: Oct. 5, 2006

(54) Method for calculating portfolio scaled IRR

(76) Inventors: Austin M. Long III, Austin, TX (US); Craig J. Nickels, Marble Falls, TX (US)

Correspondence Address: VINSON & ELKINS, L.L.P., 1001 FANNIN STREET, 2300 FIRST CITY TOWER, HOUSTON, TX, 77002-6760, US

(21) Appl. No.: 11/447,191

(22) Filed: Jun. 5, 2006

Related U.S. Application Data
(63) Continuation-in-part of application No. 10/071,864, filed on Feb. 7, 2002, now Pat. No. 7,058,583.
(60) Provisional application No. 60/266,648, filed on Feb. 6, 2001.

(51) Int. Cl. G06Q 40/00

(52) U.S. Cl. 705/35

(57) ABSTRACT

Process and system for simultaneously evaluating performance attribution for each of multiple aggregates in a private portfolio through use of a multiply neutrally-weighted portfolio created with one or more neutrally-weighted portfolio dummies.

### CROSS-REFERENCE TO RELATED APPLICATIONS

This application is a continuation-in-part of co-pending U.S. Ser. No. 10/071,864, filed Feb. 7, 2002.

### STATEMENT REGARDING FEDERALLY SPONSORED RESEARCH OR DEVELOPMENT

N/A

### BACKGROUND OF THE INVENTION

It is well established in the literature of finance that the internal rate of return (IRR) of an investment is calculated by IRR=r where

$${\sum }_{i = 0}^{n} \frac{{CF}_{i}}{{( 1 + r )}^{i}} = 0$$

The internal rate of return, or IRR of investments that require and produce a number of cash flows over time is defined to be the discount rate that makes the net present value of those cash flows equal to zero. It is understood by those of skill in the art that IRR cannot be solved directly—it must be solved iteratively using numerical methods routinely incorporated into spreadsheet and/or database software modules or functions. One of the most common library routines for solving for IRR is the XIRR function found in the various versions of Microsoft Excel®.

It is also common knowledge in the finance industry and literature that the discount rate for actual IRR (r) and the discount rate for pro form a IRR (r_{pf}) are the same when all cash flows of an investment are multiplied by a constant k:

$${\sum }_{i = 0}^{n} \frac{{kCF}_{i}}{{( 1 + {r}_{pf} )}^{i}} = 0$$

This is so because the relative weights of the cash flows are unchanged as a function of time when multiplied by a constant.

Another way to understand why multiplying each cash flow by a constant does not change the IRR of an investment is to look at the original investment as a bond and the IRR as its yield to maturity. It is obvious that buying two identical bonds at the same price on the same date and with the same cash flows (and thus the same yield to maturity) would result in a portfolio with the same yield to maturity as that of the underlying bonds. The same would be true of buying 4 bonds or k bonds. It is a small extension of the principle to apply the same notion to fractional bonds and thus to all the cash flows multiplied by any constant k.

Another technical definition of IRR is the discount rate required to make the positive cash flows (PCF) resulting from the investment equal to the negative cash flows (NCF) expended in acquiring the investment:

$${\sum }_{i = 0}^{n} \frac{{NCF}_{i}}{{( 1 + r )}^{i}} = {\sum }_{i = 0}^{n} \frac{{PCF}_{i}}{{( 1 + r )}^{i}}$$

It is therefore mathematically obvious that

$${\sum }_{i = 0}^{n} \frac{{kNCF}_{i}}{{( 1 + r )}^{i}} = {\sum }_{i = 0}^{n} \frac{{kPCF}_{i}}{{( 1 + r )}^{i}}$$

In the public markets, time weighted rate of return (TWROR) performance attribution has been refined to enable the analyst to determine the relative contribution of the stock index, sector allocation and stock selection in order to derive the manager's contribution, as shown in the numerical example below:

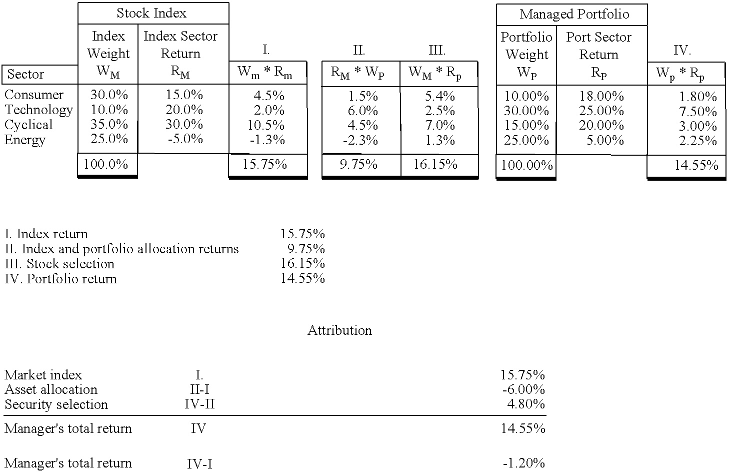

As shown in the preceding analysis, the index return (I) can be calculated as the sum of each index weight multiplied by the index sector return. The index and portfolio allocation returns (II) can be calculated as the sum of each index sector return multiplied by the portfolio weight of the sector. The stock selection return (III) can be calculated as the sum of each index weight multiplied by the portfolio sector return for each sector, and the security selection return (IV) can be calculated as the portolio weight for each sector multiplied by the respective portfolio sector returns.

Using the returns described above, the market index attribution is I. The asset allocation attribution is obtained by subtracting the market index attribution (I) from the index and portfolio allocation returns (II). The security selection attribution can be calculated by subtracting the index and portfolio allocation returns (II) from the security selection return (IV). The sum of these three attributions is then the manager's total return. Subtracting the manager's return from the market index reveals the manager's contribution, which may be either a positive or negative number, reflecting the value of the manager's decisions as compared to just investing in the index.

The above analysis depends, in part, on the availability of the index as an investible alternative; and, in part, on the fact that performance is measured by TWROR, which ignores the timing of interim cash flows. Neither of these critical factors is available in the private markets—first, because there is no investible index in the private markets; and second, because the IRR computation takes into account the timing of all interim cash flows. There is a need therefore, for methods of determining performance attribution in the private markets as well as in the public markets. Disclosed herein are new methods and means for determining performance attribution in the private markets that address the lack of an investible index, as well as the time/cash flow attributes of the IRR computation. Also disclosed herein are methods and means for performance contributions across multiple portfolio attributes.

### SUMMARY

The present disclosure thus includes a process for evaluating performance attribution in a private portfolio. Based at least in part on the discovery by the present inventors that an investment portfolio may be converted to a neutrally-weighted portfolio as described herein, the performance of a private investment portfolio can be analyzed to determine the contributions of investment selection and timing to a manager's return. The disclosed processes and systems are thus an important tool in evaluating the investment ability of portfolio managers and thus to improve their performance.

The present disclosure further includes the discovery of processes for converting a portfolio to a multiply neutrally-weighted portfolio through the use of neutrally-weighted portfolio dummies. Using these novel processes, all investments within all aggregates are simultaneously neutrally-weighted, making it possible for the first time to calculate a series of IRRs that can be algebraically combined to yield simultaneous portfolio performance attribution to multiple portfolio aggregates.

The process may be described in certain embodiments as a process for evaluating the individual contribution to portfolio IRR of each of three or more aggregates comprising:

(a) determining a multiply neutrally-weighted internal rate of return for the portfolio;

(b) determining an internal rate of return for the portfolio with actual weights for a first attribute and neutrally-weighted second and third attributes; and

(c) subtracting the IRR determined in (a) from the IRR determined in (b) to obtain the contribution of the first attribute to the IRR of the portfolio;

(d) determining an internal rate of return for a portfolio with actual weights for the first and second attributes and neutrally-weighted third attribute; and

(e) subtracting the IRR determined in (b) from the IRR determined in (d) to obtain the contribution of the second attribute to the IRR of the portfolio;

(f) determining an actual internal rate of return for the portfolio with actual weights for all aggregates; and

(g) subtracting the IRR determined in (d) from the IRR determined in (f) to obtain the contribution of the third attribute to the IRR of the portfolio.

The first, second and third attributes can be, in any order, allocation of assets, vintage, selection, or any other attribute described herein, or known in the art.

The present disclosure further provides processes for producing a multiply neutrally-weighted portfolio from a private investment portfolio. The processe include:

(a) scaling the investments of an instance of an aggregate within the private investment portfolio to an arbitrary constant;

(b) cross-footing the scaled investments obtained in (a) to obtain an unscaled dummy;

(c) scaling the unscaled dummy to the same constant used to scale the investments in (a) to obtain a scaled dummy; and

(d) using as many scaled dummies as are required to achieve the same number of investments within all instances and the same number of instances within all aggregates of interest in the portfolio.

In the practice of the processes, the fundamentals can be cash flows and can be scaled to any abritrary constant. In certain embodiments, the fundamentals are scaledto the mean of the fundamentals.

The system described herein includes a central processing unit or CPU, which may be a mainframe computer connected to one or more work stations, or it may be a component of a personal computer that may be a “stand alone” computer or it may be networked to other computers through a common server.

Without the use of neutral weighting (NWP) it is impossible to calculate the constituent components of a portfolio IRR. By using a refinement of NWP to obtain neutrally-weighted portfolio dummies (“NWPD”) for the all of the aggregates contained in the portfolio, and using NWPDs to develop a multiply neutrally-weighted portfolio (“MNWP”) in which all investments within all aggregates are simultaneously neutrally-weighted, it is possible to calculate a series of IRRs that can be algebraically combined to yield portfolio performance attribution to multiple portfolio aggregates.

In the present disclosure, “algebraically combining” is understood to convey its ordinary meaning in the art, and as used in the examples herein, is the addition of numbers with positive and negative signs.

### BRIEF DESCRIPTION OF THE DRAWINGS

FIG. 1 is a diagram showing the structure of a Gatekeeper or Fund of Funds investment portfolio.

FIG. 2 is an example of a portfolio containing two asset classes, venture capital and leveraged buyout, and two vintages, 2000 and 2001.

FIG. 3 is an example of a portfolio used to demonstrate the calculation of a neutrally-weighted portolio dummy (NWPD).

FIG. 4 is an example of the calculation of a multiply neutrallyweighted portfolio (MNWP), using neutrally-weighted portfolio dummies (NWPDs).

FIG. 5 is an example of a calculation of portfolio IRR given actual allocation weights combined with neutrally-weighted vintage and selection weights.

FIG. 6 is an example of a calculation of portfolio IRR given actual allocation and vintage weights combined with neutrally-weighted selection weights.

FIG. 7 is an example of a calculation of portfolio IRR omitting all neutrally-weighted portfolio dummies and using the actual weights for all investments.

FIG. 8 shows the relevant permutations of the neutrally-weighted portfolio calculation in FIGS. 4-7 combined to determine simultaneously the portfolio's performance attribution to asset allocation, vintage and investment selection.

### DETAILED DESCRIPTION

Calculation of Neutrally-Weighted IRR

In a diversified portfolio setting, although the IRR of each investment is unchanged when all its cash flows are multiplied by a constant, multiplying or dividing each of the i period cash flows of each of j investments in a portfolio of m investments by a scaling factor fₛ changes the IRR of the portfolio to a constant value IRRκ while leaving the IRR of each investment unchanged. Thus,

$$IRR κ = {r}_{pf} where$$

$${\sum }_{i = 0}^{n} \frac{{\sum }_{j = 1}^{m} {f}_{j} {CF}_{i - {i}_{0} , j}}{{( 1 + {r}_{pf} )}^{i - {i}_{0}}} = 0 and {f}_{j} = \frac{k}{{\sum }_{i = 0}^{n} {NCF}_{i , j}}$$

This is so because, as described above, the relative weight of each investment's contribution to the portfolio's cash flows is the same as a function of time. Since the relative weights are the same no matter what constant is used to scale the cash flows of the individual investments (i.e., the portfolio is neutrally-weighted), the IRR of the neutrally-weighted (i.e., scaled) portfolio is a constant.

The numerical examples below make it clear that a neutrally-weighted portfolio, in which the cash flows of all investments in a portfolio are scaled to a common constant, has two important financial and mathematical characteristics: the IRRs of the individual investments are unchanged; and the portfolio's IRR is a constant no matter what factor is used to scale the portfolio to a neutral weight.

| | |
|---|---|
| 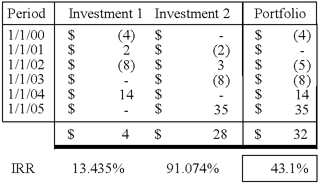 | 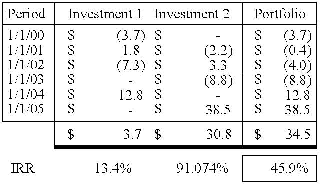 |

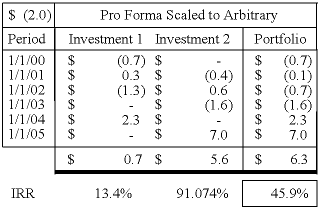

| | |
|---|---|
| 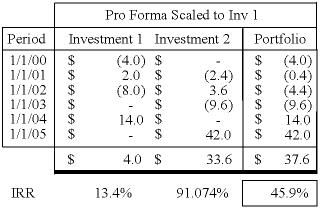 | 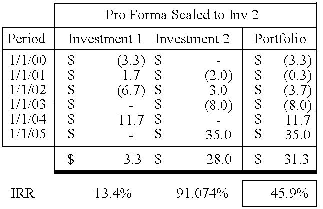 |

Another way of stating the relationship of a neutrally-weighted portfolio's constant IRR to the constant IRR of a single investment's cash flows is shown in the following numerical example/diagram, in which the vertical arrow shows the latter and the horizontal arrows show that the former is equivalent to the latter:

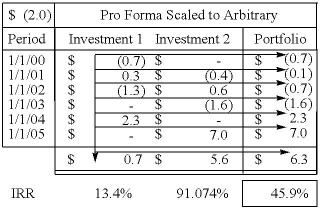

In summary, scaling the cash flows of each of a portfolio's investments to a common standard results in a neutrally-weighted portfolio. In a neutrally-weighted portfolio, the portfolio's cash flows are made up of equally-weighted investments, thus removing the effects of the relative dollar weighting of the investments from the portfolio IRR. Because the relative weights of the investments are eliminated as an influence on IRR, the portfolio IRR is a constant, no matter how the common weights are determined.

The investment meaning of the neutrally-weighted portfolio's constant IRR can be used as a performance diagnostic by comparing it to the conventional portfolio IRR. The difference between the two is caused by the relative weighting of investments (or, in public stock terms, stock selection). In private market terms, this comparison determines the relative efficiency with which the managers invested their capital. If the neutrally-weighted portfolio's IRR is less than the conventional portfolio IRR, the managers invested more money in the best-performing transactions and less money in the worst-performing transactions. Conversely, if the neutrally-weighted portfolio IRR is greater than the conventional portfolio IRR, the managers invested more money in the worst-performing transactions and less money in the best-performing transactions. Obviously, the former is preferable to the latter in terms of investment efficiency.

For all the reasons cited above as to why the neutrally-weighted portfolio's IRR is constant, the times money earned measure, (“TME”), which is calculated as the total amount of money returned, plus the ending value if the investment is unrealized, divided by the total amount of money invested is also different from actual and is also a constant.

In the same fashion as cited in the previous paragraph, a times money earned measure in the actual portfolio that is greater than that of the neutrally-weighted portfolio indicates that the managers invested more money in the best-performing transactions and less money in the worst-performing transactions. Conversely, if the neutrally-weighted portfolio times money measure is greater than the conventional portfolio times money, the managers invested more money in the worst-performing transactions and less money in the best-performing transactions. Again, the former is preferable to the latter in terms of investment efficiency.

Means for Using the Neutrally-Weighted Portfolio's Constant IRR and both the Zero-Based IRR and Actual IRR to Calculate Private Investment Performance Attribution

The following disclosure shows in detail the use of the neutrally-weighted portfolio's constant IRR, as calculated above, and actual IRR, as calculated in the Background Section above, to analyze performance attribution in the private markets in terms of
1. relative weighting of investments (i.e., stock selection, whether the managers put more money in the better transactions);
2. relative timing of investments (i.e., whether the managers' track record reflects fortunate timing, rather than investment skill); and
3. the manager's return against the portfolio index (as defined in the box below).

In order to analyze performance in these terms, the following is needed:

| | $ | t | | |
|---|---|---|---|---|
| I | Neutral | Zero- | Porfolio index = neutrally-weighted | 52.8% |
| | weight | based | portfolio w/zero-based start date | |
| II | Actual | Zero- | Actual weights, w/common start | 49.4% |
| | | based | date | |
| III | Neutral | Actual | Neutrally-weighted portfolio w/actual, | 45.9% |
| | weight | | start dates | |
| IV | Actual | Actual | Actual weights, w/actual start dates | 43.1% |
| | | | (conventional IRR) | |

I. Using both the neutrally-weighted portfolio IRR and the time-zero IRR together eliminates both time and investment weighting. The return to the portfolio eliminating the effects of both weighting/investment selection and timing results in a custom index of investments using the portfolio as the investment universe. Using the same figures as the Pro Form a Scaled to Arbitrary numerical example above:

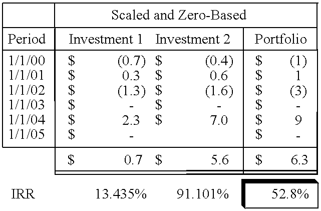

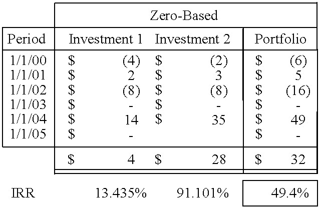

II. The Calculation of neutrally-weighted IRR gives equal weight to each investment in a portfolio, eliminating the effect of the relative weight of each investment in determining IRR and thus yielding a constant portfolio IRR. If more money has been invested in the poorest investments, the actual IRR of the portfolio will be less than the portfolio scaled IRR. If more money has been invested in the best investments, the actual IRR will be greater than the portfolio scaled IRR. Using the numerical example cited above,

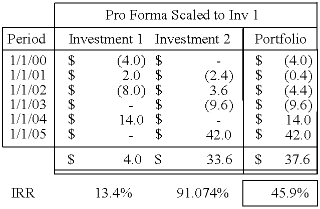

Since the 45.9% IRR of the neutrally-weighted portfolio exceeds the 43.1% IRR of the manager's portfolio, the example shows that the manager's stock selection (i.e., relative weighting of the investments in the portfolio) actually detracted from returns. In other words, naive or neutral weighting would have yielded superior returns to the actual weighting of the portfolio's investments.

III. The actual portfolio return, using the numerical example cited above is as follows:

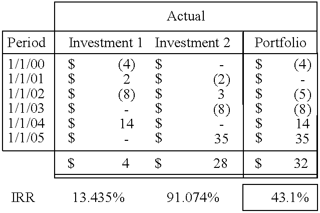

With these figures known, the manager's performance is analyzed as follows:

| | | |
|---|---|---|
| I | Portfolio index | 52.8% |
| II − I | Selection (relative weighting) | −3.3% |
| IV − II | Timing | −6.4% |
| IV | Manager's return | 43.1% |
| IV − I | Manager's contribution | −9.7% |

The IRRs total properly to the manager's return in this analysis, a property derived from the fact that the selection IRR and timing IRR each have only a single changed parameter, whether dollar weight or time, from the line immediately preceding. Put another way, these IRRs foot properly because there are no intervening unexplained factors relating to performance.

An aspect of the present disclosure is that the processes involving the neutrally-weighted portfolio can be extended to be even more useful. Using the neutrally-weighted portfolio as described above, neutral weights can only be calculated within single portfolio attributes (viz., portfolio vintages, portfolio sub-asset classes and other aggregations of like investments) and not simultaneously across those attributes. For example, the NWP calculation can be used to neutrally weight either assets within vintages or assets within sub-asset classes but not assets within sub-asset classes across vintages (i.e., neutrally-weighted in all three dimensions—assets, sub-asset classes and vintages) at the same time. This desirable property—a portfolio neutrally weighted simultaneously as to its assets, its sub-asset classes and its vintages—is termed in the present disclosure, a multiply neutrally-weighted portfolio (“MNWP”).

One of skill in the art will understand that at the lowest level the database records are individual cash flows and valuations, each with its own date. The usual first aggregate of each set of cash flows and valuations, and thus the lowest level of aggregation in most institutional private equity portfolio management software, is at the investment partnership level (referred to here as the “fund” level). Some institutional investors also track the individual cash flow and valuation events of the specific corporate securities or other investment vehicles (e.g., interests in other partnerships, working interests or net profit interests in oil & gas and the like) in which each fund invests. In the following description, it is assumed that the cash flow and valuation records in the database aggregate, at the lowest level, to the investments made by the funds, which are usually (but not necessarily) corporate securities. However, the disclosure and the processes described herein are not so limited.

In order to aggregate the individual cash flow and valuation records at any level, each record in a database must contain fields denoting each aggregate and tagging each record in the database with that property. Only then can the individual cash flow and valuation records be summed into the cash flows and valuations of a particular aggregate. Potential aggregates in a database of private equity cash flows and valuations include, but are not limited to the following:

A) Gatekeeper (or Fund of Funds or Separate Account Manager) Name

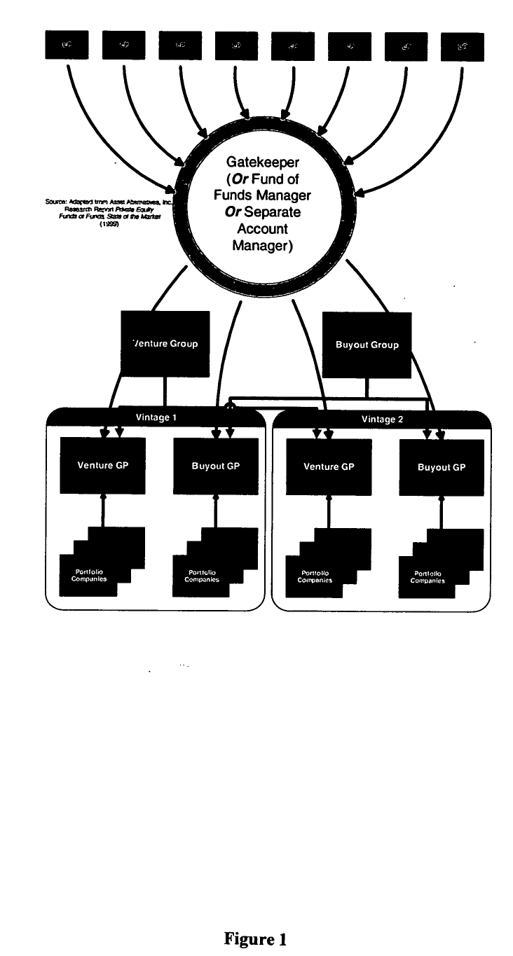

The diagram shown in FIG. 1 incorporates many of the potential aggregates. Note that the Gatekeeper (or Fund of Funds or Separate Account Manager) doesn't invest directly into portfolio companies. Rather, the Gatekeeper (or Fund of Funds or Separate Account Manager) invests in fluds (here divided into two typical Sub-Asset Classes, venture capital and buyouts) and the fluds invest in portfolio companies. Furthermore, the Gatekeeper (or Fund of Funds or Separate Account Manager) typically invests over more than one Vintage and in more than one Sub-Asset Class.

B) Fund Group Name

In FIG. 1, the Fund Group Names are identified as Venture Group and Buyout Group. In the private equity industry, some Fund Groups (e.g., Carlyle and Texas Pacific Group) have many funds in the market representing several Sub-Asset Classes. Other Fund Groups manage only serially-raised single-Sub-Asset Class funds (e.g., Kleiner Perkins Caufield & Byers, which has now raised at least 12 venture capital funds over many Vintages).

C) Other Aggregates Would be Any Required Aggregate in the Computation of Portfolio Performance Under the ICFA/GIP Reporting Standards.

D) Sub-Asset Class

This is perhaps the most varied classification/grouping/aggregate in the private equity industry. Some consultants maintain databases containing as many as twenty distinct Sub-Asset Classes. Examples include, but are not limited to, broad categories (venture capital, buyouts, distressed securities, mezzanine, secondary interests, corporate finance and the like); and much more narrowly defined categories (early-stage venture capital vs later-stage venture capital vs diversified venture capital, and small-market [<$400 million] buyouts vs. mid-market buyouts [>$400 million and <$1 billion] vs large-market buyouts [>$1 billion]).

E) Domicile

Primarily International vs Domestic, although some private equity portfolio managers include domestic domiciles (e.g., northeast, southwest or even such narrow distinctions as California-based or Connecticut-based).

F) Status

Most private equity portfolio managers distinguish between Active vs Liquidated investment partnerships.

G) Vintage

The term “vintage” refers to the year in which one or more partnerships closed. Some private equity portfolio managers define “vintage” as the year in which the partnership first called capital (as opposed to the year in which the partnership closed).

H) Local Currency

Partnerships domiciled outside the U.S. may do business in one or more local currencies (e.g., the pound sterling, the euro, the renminbi, etc.).

I) Industry Focus

Some investment partnerships invest along narrow industry lines (e.g., telecom, software, manufacturing and the like). Some private equity portfolio managers define Industry Focus to include concentration on a particular stage of the production process without regard to the particular industry involved (e.g., manufacturing vs wholesale distribution vs retail distribution). Most non-venture capital partnerships invest in a diversified set of industries and in all or most of the stages of production, rather than in a single industry or stage of production or even one or two industries or stages of production.

J) Geographic Focus

While Domicile defines the locality in which an investment partnership is based, Geographic Focus defines the physical area within which the investment partnership concentrates in generating deal flow and in investing its capital. A domestic partnership might concentrate on a single state, a group of states (e.g., the so-called Sun Belt) or a region of the United States. A partnership the Domicile of which is International, for example, might focus solely on France; it also might focus on a broader but well-defined geographic area such as Europe; a trade area, such as the European Union; or the area using a particular currency, such as the euro or the renminbi. Some partnerships refer to themselves (and are referred to by most private equity industry investors) as global and therefore not focused on any particular geographic area either within the U.S. or abroad. Within the U.S., some partnerships refer to themselves (and are referred to by most private equity investors) as national, meaning that they do not concentrate on any particular area within the U.S.

K) Fund Investment Name

The term Fund Investment Name refers to the actual investments (usually corporate equity and/or debt and/or warrants to purchase equity or debt at discounted prices) made by the partnerships in which, in the diagram above, the Gatekeeper (or Fund of Funds Manager or Separate Account Manager) invests. The most basic unit in the database referred to throughout this memorandum is a single record of a single cash flow or valuation for a single Fund Investment Name on a particular date. All of the aggregates, including the Fund Investment Name (the lowest-level aggregate contained in this disclosure) are the product of adding together all of the cash flows (with capital invested using negative numbers and capital distributed using positive numbers) and valuations (always using positive numbers) comprising the investment history of each Fund Investment Name.

It is possible to further divide Fund Investment Name into Security Types, e.g., common stock, preferred stock (potentially further divided into subcategories such as cumulative vs non-cumulative, current pay vs PIK, etc), debt (potentially further divided into subcategories such as secured vs. unsecured, floating rate vs constant rate, current pay vs PIK, etc.) and so on through the lengthy list of potential securities invested in by find managers in the private equity industry. Each of the aggregates listed above can, in all likelihood, be further subdivided in this manner at the whim or fancy of particular portfolio managers. The aggregates set forth in detail herein are simply examples of typical investment aggregates in the private equity markets. These aggregates are neither exhaustive nor all-inclusive, but are simply representative.

The importance of aggregates in the context of a database of private equity cash flows and valuations is that the description herein of a Multiply Neutrally-Weighted Portfolio (“MNWP”) teaches one of skill in the art how to use Neutrally-Weighted Portfolio Dummies (“NWDs”) to neutrally-weight any number of these aggregates simultaneously and how to algebraically manipulate the resulting IRRs to enable the analyst to attribute to each aggregate its contribution to the total performance of the portfolio (i.e., the total IRR of the portfolio). The use of NWPDs can neutrally-weight more than three aggregates and therefore make it possible to determine the contribution of each of three or more aggregates to total portfolio performance. However, as the number of aggregates simultaneously neutrally-weighted rises, the permutations of the number of aggregates used rises rapidly and thus makes the algebraic manipulation required to assess the contribution of each of the aggregates to total portfolio IRR more difficult. The examples herein use no more than three aggregates in order to make it easier to explain the workings of the MNWP, including the development of the NWPDs that make it possible. It is understood, however, that 4, 5, or even 10 or more aggregates may be considered, and the upper limit is based only on the amount of computing power one chooses to expend.

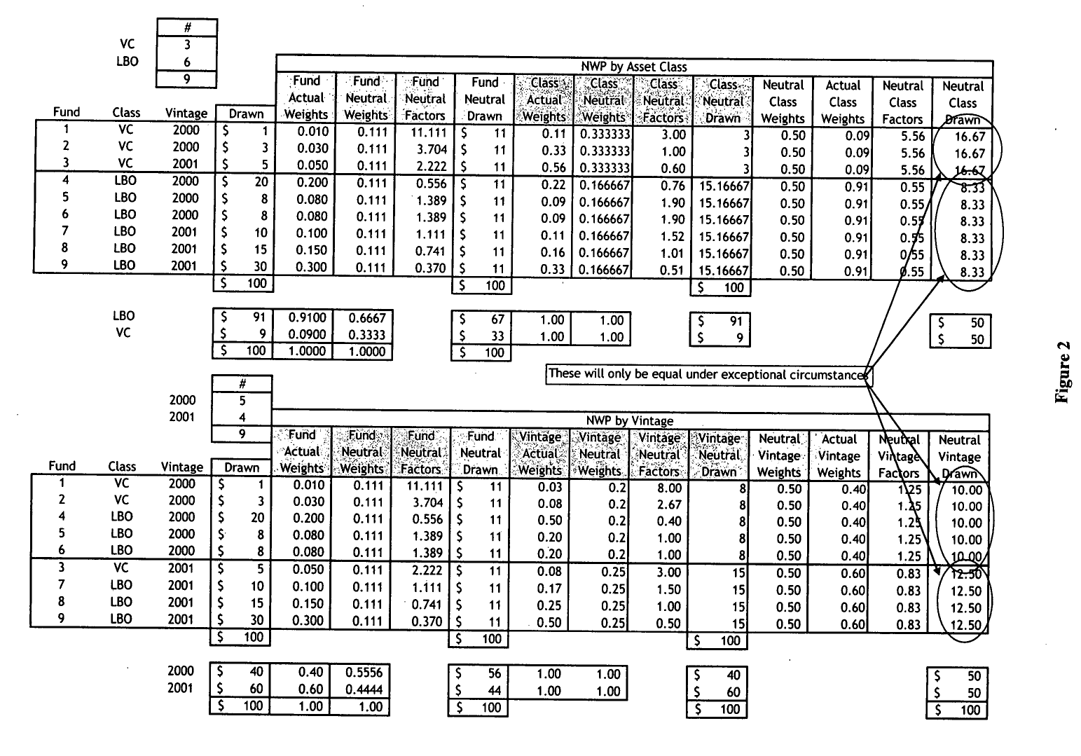

As illustrated in FIG. 2, using the NWP method previously disclosed, two or more sub-asset classes cannot be simultaneously neutrally weighted because they are not both comprised of exactly the same number of assets. Similarly, two or more vintages cannot be simultaneously neutrally weighted because they are not both comprised of exactly the same number of assets. Finally, two or more sub-asset classes in two or more vintages cannot all be simultaneously neutrally weighted because all of the sub-asset classes and all of the vintages do not contain exactly the same number of assets. A table of actual cash flows used to generate FIG. 2 is shown in Table 1.

To show why this must be so in mathematical terms:
Let q=the number of asset aggregates of interest (in the example, q=2−the aggregates are sub-asset class and vintage); r=the number of instances that comprise q (in the example, r_{class}=2 because there are two sub-asset classes and r_{vintage}=2 because there are two vintages); p_{rq}=the number of assets (usually individual investments but also, for example, funds within a fund of funds) within instance r of aggregate q (in the example, p_{classVC}=3, p_{classLBO}=6, p_{vintage2000}=5 and p_{vintage2001}=4); and k_{rq}=the scaling factor used for the rth instance of the q^{th} attribute.
When the assets within a particular instance of a single aggregate are neutrally-weighted, the negative cash flows of each asset within each instance of that aggregate are scaled to k_{rq}. In order to achieve the multiple levels of neutrality required, all k_{rq} must be equal. Each of the assets within a particular instance of a single aggregate therefore comprises k/p_{rq} of the neutrally-weighted total of that instance of that aggregate. It therefore follows that for all assets within all instances of all aggregates to be equally weighted, all p_{rq} must be equal.

Therefore, what is needed, in order to simultaneously neutrally weight all assets, all instances and all aggregates, is for each instance r of each of the q aggregates to contain exactly the same number of assets p as all the other instances of all the other aggregates. The paragraphs below disclose methods and means for obtaining a series of neutrally-weighted portfolio dummies (“NWPDs”) in order to simultaneously neutrally weight all assets, all instances and all aggregates and for using the resulting simultaneously neutrally-weighted assets, instances and aggregates to calculate performance attribution, both within the portfolio and against an industry benchmark.

Obtaining the NWPD:

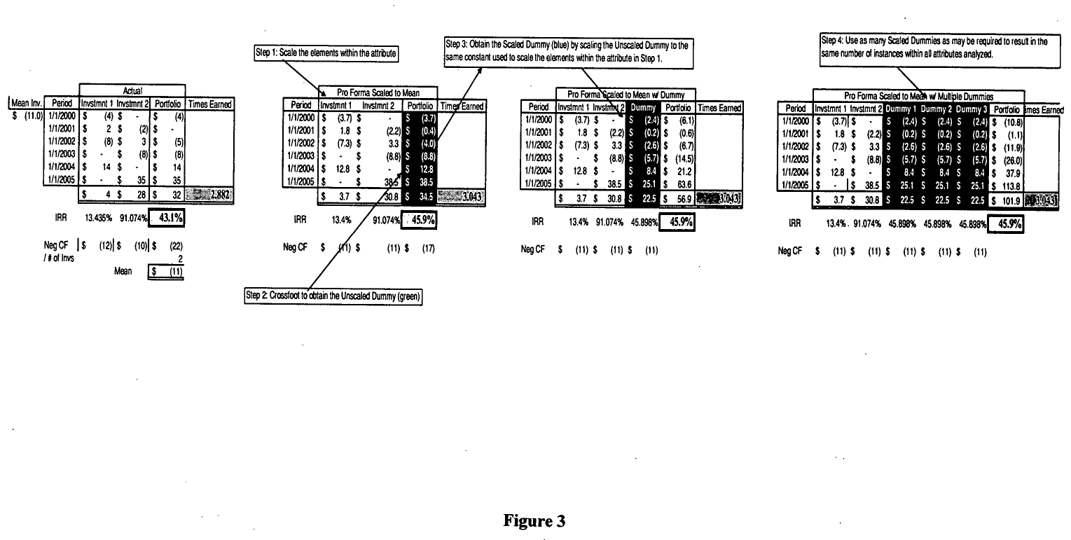

Calculation of an NWPD is a refinement and extension of the NWP calculation shown above. In the case of NWP, all cash flows are scaled to a common standard. In the case of an NWPD, the cross-footed NWP of all of the investments within an instance of an aggregate of the portfolio is scaled back to the same standard used to calculate the NWP and then used as a dummy (i.e., filler) to increase the number of investments within that instance of that aggregate of the portfolio without changing the IRR of either that instance of that aggregate or of the portfolio. Any number of NWPDs can be used without affecting the portfolio's IRR, as FIG. 3 below, demonstrates. As used herein, footing and cross-footing are meant to convey their ordinary meanings in the field of accounting, wherein footing means adding all the lines in a column of numbers to reach a total for the column and cross-footing means adding all of the columns in a line of numbers to reach a total for the line.

There are four fundamental steps utilized to calculate the NWPD. The first step is to scale the investments within each instance of each aggregate to be considered. Just as in the NWP, all the cash flows of a particular instance of a particular aggregate can be scaled to the mean, to the smallest, to the largest or to any other common standard. In step 2, the scaled cash flows are cross-footed to obtain the unscaled dummy. Step 3 is to scale the unscaled dummy using the same constant previously used to scale the investments within the same instance of the same aggregate as step 1, to obtain the scaled dummy. The fourth step is to use as many scaled dummies as may be required to achieve the same number of investments in all instances of all the aggregates to be analyzed.

The source of the NWPD is simple but powerful. Its cash flows are comprised of the aggregate cash flows of the portfolio, all with exactly the same timing as the portfolio. Put simply, from the perspective of the NWP, the NWPD, prior to being scaled back, represents the entire portfolio. Thus, when it is then given the same weight as all of the other components that make it up, it remains just as neutral within the portfolio as the other components. At the same time, it retains all of the cash flow characteristics (weights and timing) of all of the aggregate cash flows from which it is calculated. Using NWPDs obtained as disclosed above to develop MNWP.

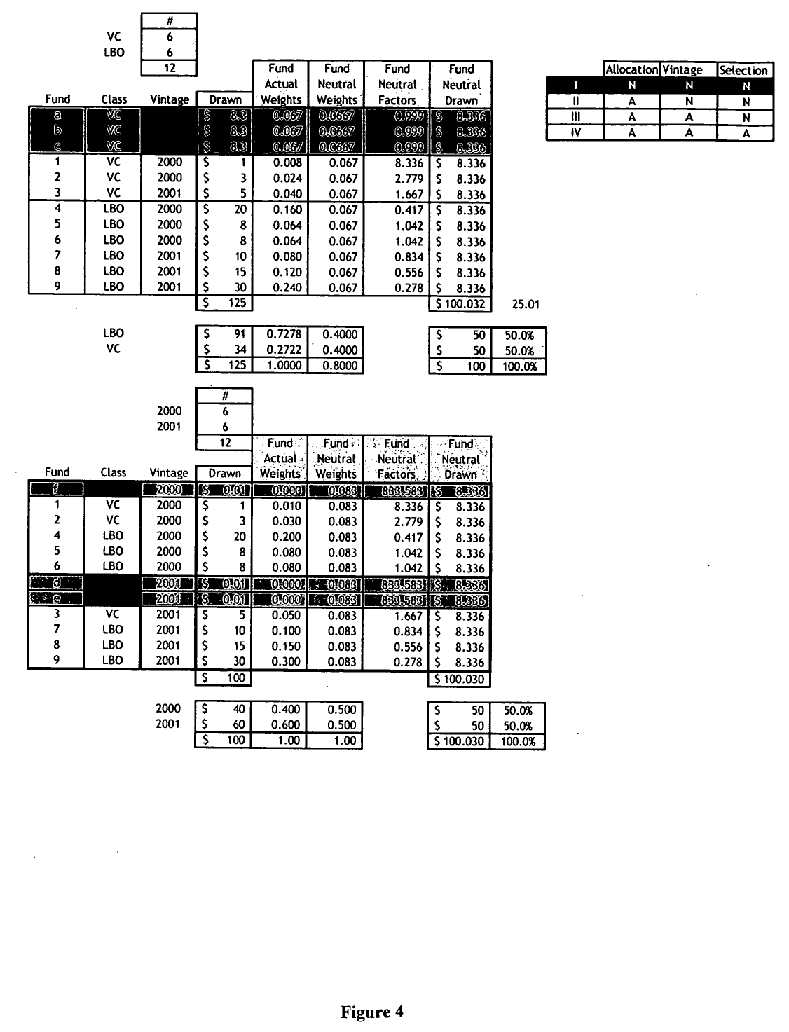

Once an NWPD has been calculated for a particular instance of a particular aggregate, as shown in FIG. 4, it can be used to increase the number of assets within that instance of that aggregate in order to make the number of assets in all instances of all aggregates equal and thus to simultaneously neutrally weight all assets within all instances of all aggregates. The cash flows and calculation of IRR shown in FIG. 4 can be found in Table 2. In this case, where p_{classVC}=3, p_{classLBO}=6, p_{vintage2000}=5 and p_{vintage2001}=4, NWPDs must be calculated for all instances of all aggregates to raise all of the smaller p_{rq} to the largest number: 6. Calculating performance attribution of a private investment portfolio using multiple portfolio aggregates

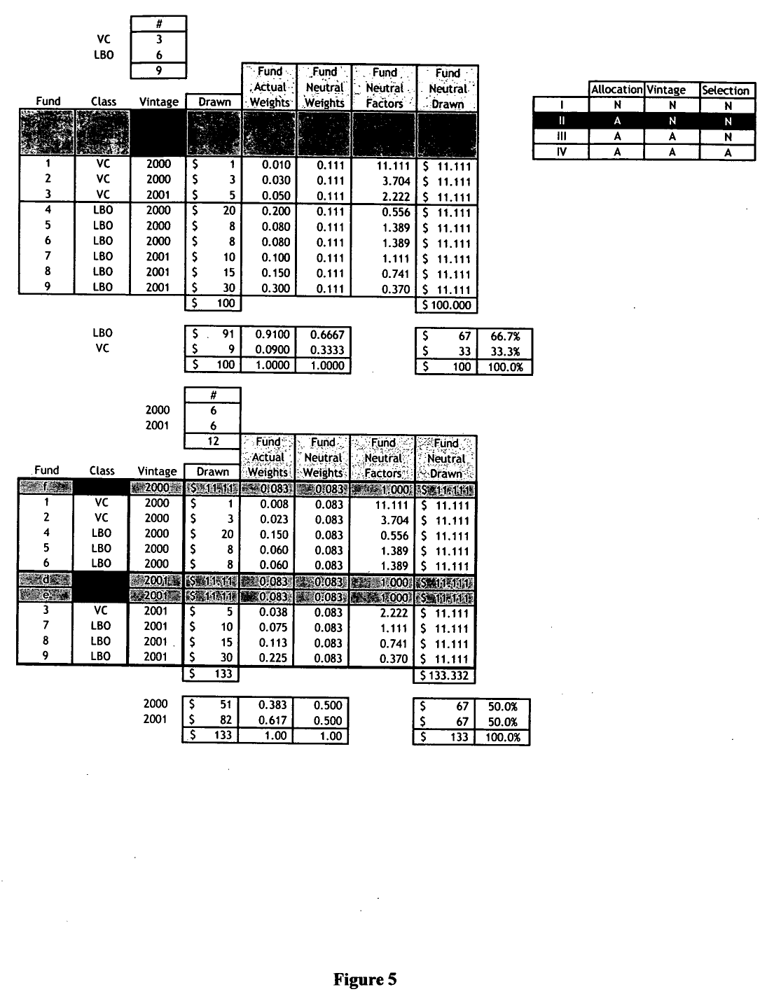

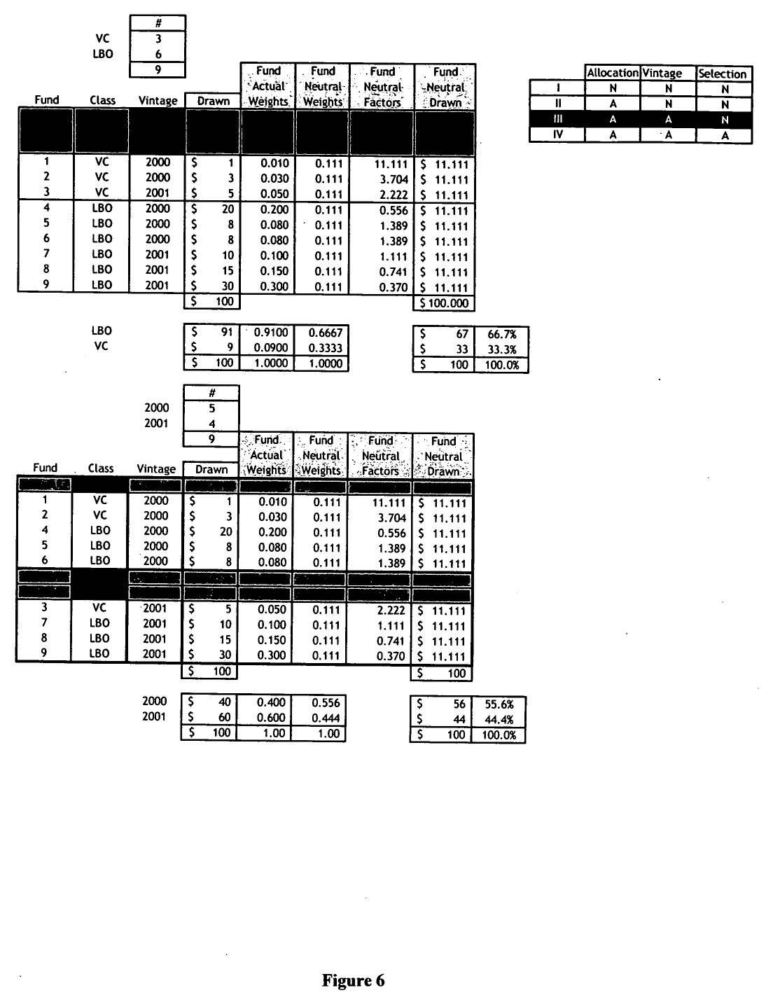

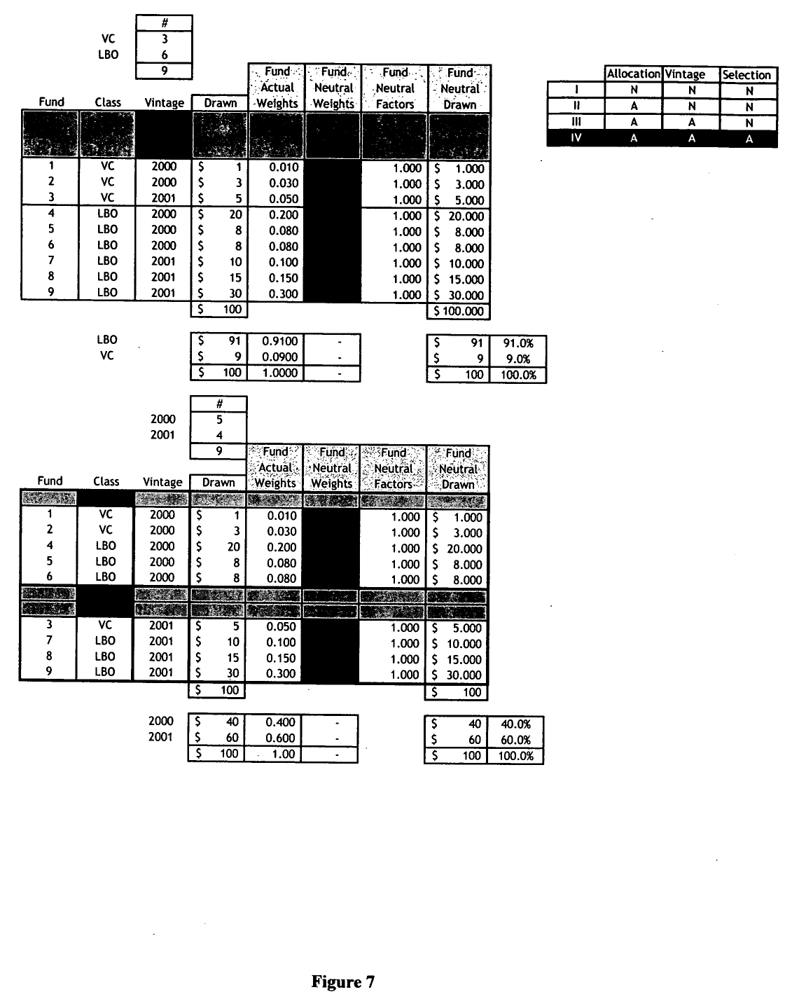

Once the MNWP has been calculated using the NWPDs obtained as outlined above, other relevant permutations of the neutral portfolio can be calculated by simply including or excluding the appropriate NWPDs, as shown in FIGS. 5 and 6. Finally, all of the investments, instances and aggregates in FIG. 7 are their actual weights. The cash flows used in the calculations of FIG. 5 and FIG. 6 are shown in Tables 3 and 4, respectively. Calculations of IRR shown in FIG. 7 are based on cash flows shown in Table 5.

In order to isolate the effect of each aggregate, it is necessary to compute portfolio IRR with and without the NWPDs. For example in order to calculate portfolio IRR given actual Allocation weights combined with neutral Vintage weights and Selection weights, all that is required is to omit the Allocation NWPDs, as shown in FIG. 6, leaving the actual Allocation weights. After the effects of each of the instances of each of the aggregates of interest have been calculated, the actual-weight portfolio IRR is calculated by omitting all NWPDs and using the actual weights for all investments as shown in FIG. 7.

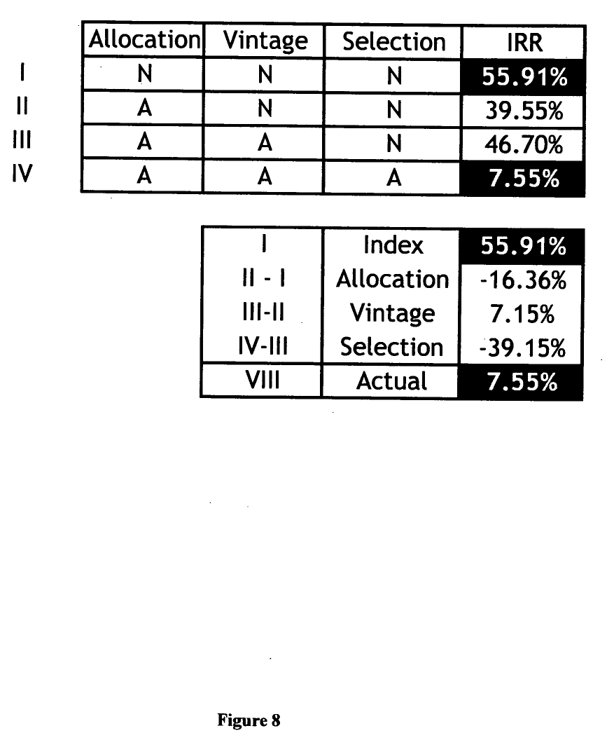

The relevant permutations of the neutrally-weighted portfolio calculated in FIGS. 4-7 above can then be combined as shown in FIG. 8 to determine simultaneously the portfolio's performance attribution to sub-asset allocation (the relative weighting of sub-asset classes), vintage (the relative weighting of the vintages) and selection (the relative weighting of the individual assets).

It is a further aspect of the disclosure that all components of the final product can also be calculated using the zero-based IRR method, in which all investments are presumed to begin at a common start date, typically the date of inception of the oldest investment in the portfolio, and the MNWP together. When the components calculated using the zero-based IRR method and the MNWP method together are subtracted from the corresponding components calculated using MNWP alone, the result is the contribution of timing to each of the performance attribution components.

TABLE 1

| | Actual Cash Flows | | | | | | | | |
|---|---|---|---|---|---|---|---|---|---|
| Inv # | 1 | 2 | 3 | 4 | 5 | 6 | 7 | 8 | 9 |
| Inv Type | VC | VC | VC | LBO | LBO | LBO | LBO | LBO | LBO |
| Inv Vintage | 2000 | 2000 | 2001 | 2000 | 2000 | 2000 | 2001 | 2001 | 2001 |
| 1/2000 | ($0.333) | | | ($6.667) | | | | | |
| 2/2000 | | ($1.000) | | | ($2.667) | | | | |
| 3/2000 | | | | | | ($2.667) | | | |
| 4/2000 | ($0.333) | | | ($6.667) | | | | | |
| 5/2000 | | | | | ($2.667) | | | | |
| 6/2000 | | ($1.000) | | | | ($2.667) | | | |
| 7/2000 | | | | ($6.667) | | | | | |
| 8/2000 | ($0.333) | | | | ($2.667) | | | | |
| 9/2000 | | ($1.000) | | | | ($2.667) | | | |
| 10/2000 | | | | | | | | | |
| 11/2000 | | | | | | | | | |
| 12/2000 | | | | $1.000 | | | | | |
| 1/2001 | | | ($1.667) | $2.000 | | $1.000 | ($3.333) | | |
| 2/2001 | $0.500 | | | | | | | ($5.000) | |
| 3/2001 | | | | | $2.000 | $1.000 | | | ($10.000) |
| 4/2001 | $0.200 | | | | | | | | |
| 5/2001 | | | ($1.667) | | | | ($3.333) | | |
| 6/2001 | $0.100 | | | | | | | ($5.000) | |
| 7/2001 | | $3.500 | | | $4.000 | | | | ($10.000) |
| 8/2001 | | $2.000 | | | | $3.000 | | | |
| 9/2001 | | | ($1.667) | | | | ($3.333) | | |
| 10/2001 | | | | | | | | ($5.000) | ($10.000) |
| 11/2001 | | | $4.000 | | | | | | |
| 12/2001 | $2.000 | $4.000 | $3.000 | $4.000 | $1.000 | $2.000 | $14.000 | $17.000 | $35.000 |
| Total Drawn | $1 | $3 | $5 | $20 | $8 | $8 | $10 | $15 | $30 |
| Total ROC | $0.800 | $5.500 | $4.000 | $3.000 | $6.000 | $5.000 | $0.000 | $0.000 | $0.000 |
| Total ROC + Value | $2.800 | $9.500 | $7.000 | $7.000 | $7.000 | $7.000 | $14.000 | $17.000 | $35.000 |
| TME | 2.800000 | 3.166667 | 1.400000 | 0.350000 | 0.875000 | 0.875000 | 1.400000 | 1.133333333 | 1.166666667 |
| IRR | 108.64% | 140.74% | 82.71% | −54.60% | −11.14% | −11.21% | 74.55% | 27.90% | 40.18% |

TABLE 2

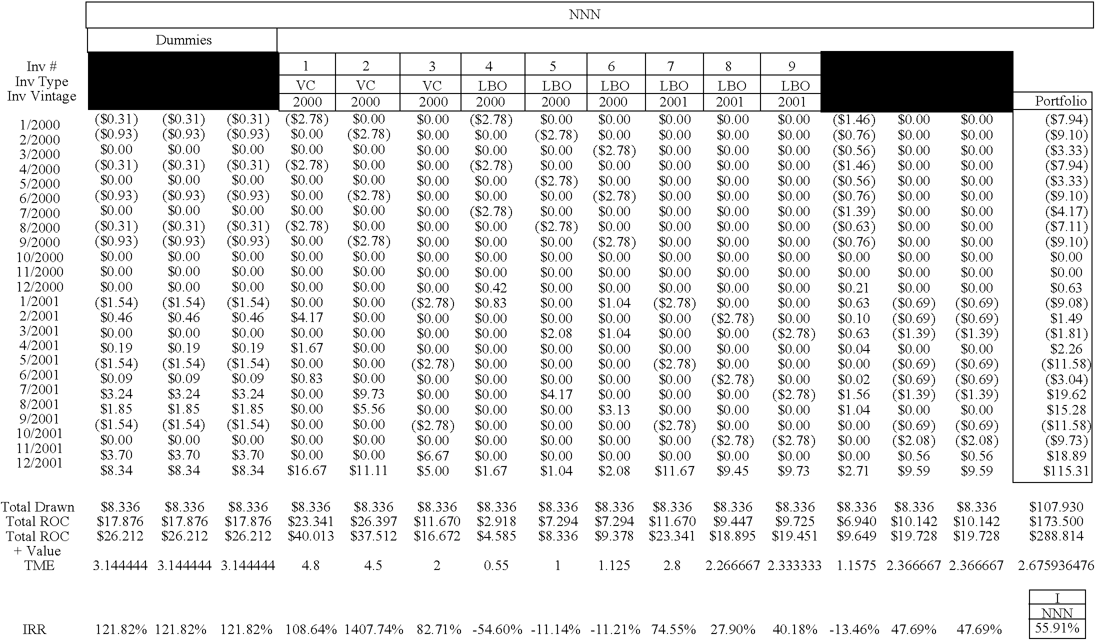

TABLE 3

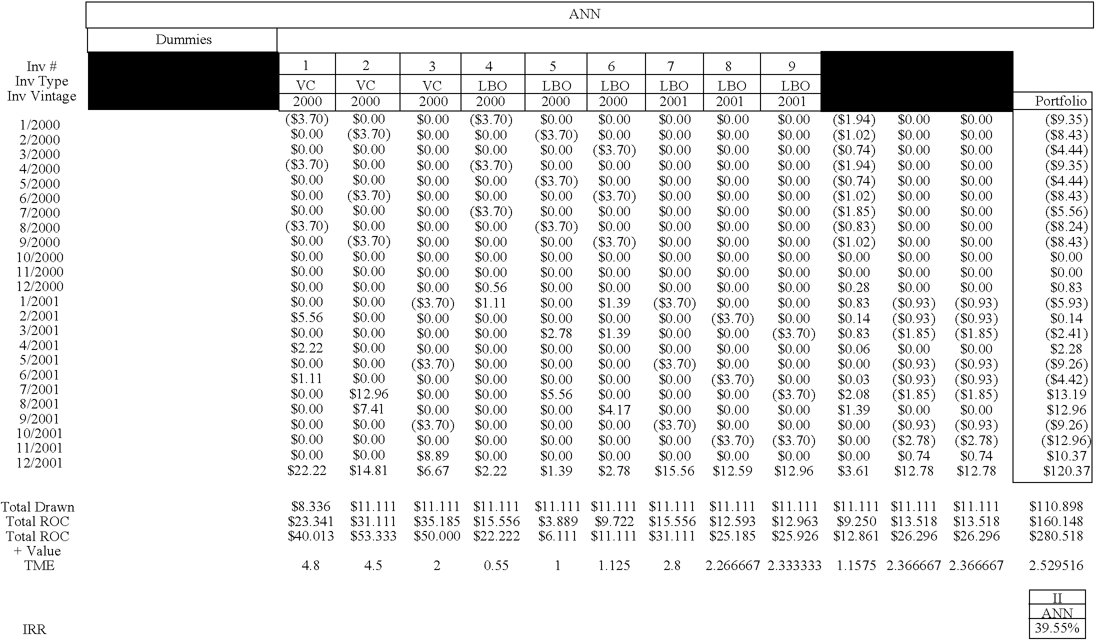

TABLE 4

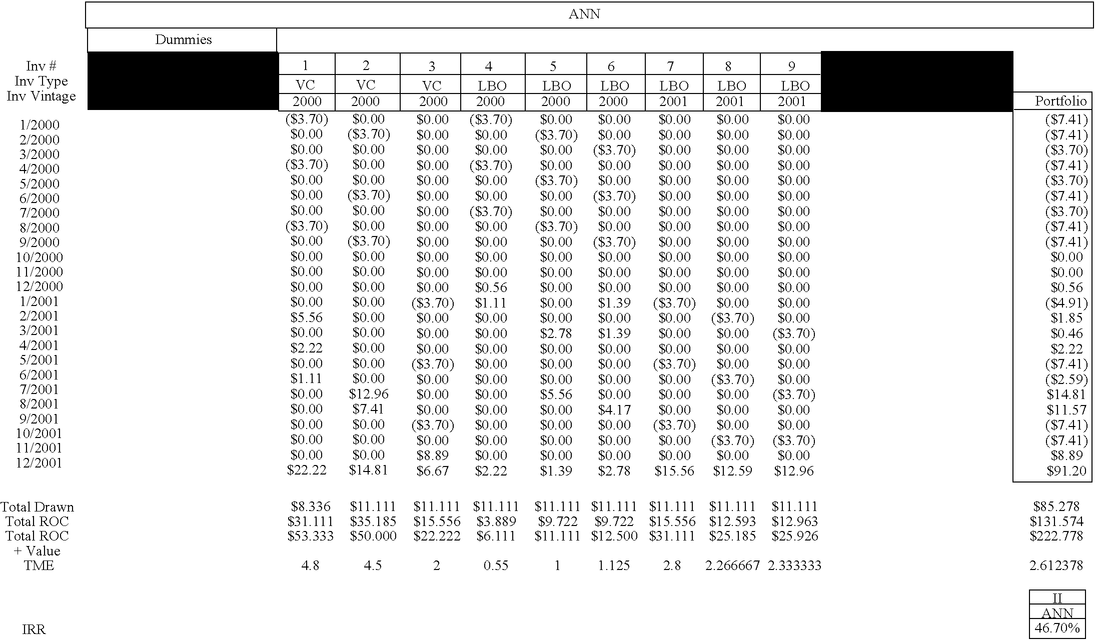

TABLE 5

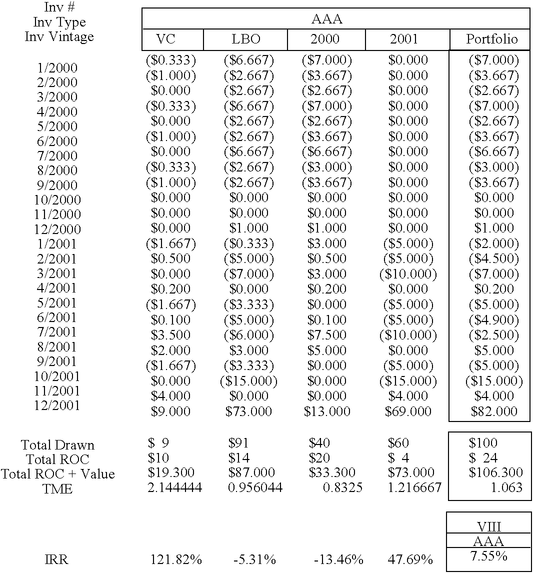

1. A process for evaluating the individual contribution to portfolio IRR of each of three or more aggregates comprising:
(a) determining a multiply neutrally-weighted internal rate of return for the portfolio;
(b) determining an internal rate of return for the portfolio with actual weights for a first attribute and neutrally-weighted second and third attributes; and
(c) subtracting the IRR determined in (a) from the IRR determined in (b) to obtain the contribution of the first attribute to the IRR of the portfolio;
(d) determining an internal rate of return for a portfolio with actual weights for the first and second attributes and neutrally-weighted third attribute; and
(e) subtracting the IRR determined in (b) from the IRR determined in (d) to obtain the contribution of the second attribute to the IRR of the portfolio;
(f) determining an actual internal rate of return for the portfolio with actual weights for all aggregates; and
(g) subtracting the IRR determined in (d) from the IRR determined in (f) to obtain the contribution of the third attribute to the IRR of the portfolio.

2. The process of claim 1, wherein the first attribute is allocation of assets.

3. The process of claim 1, wherein the second attribute is vintage.

4. The process of claim 1, wherein the third attribute is selection.

5. A process for producing a multiply neutrally-weighted portfolio from a private investment portfolio comprising:
(a) scaling the investments of an instance of an aggregate within the private investment portfolio to an arbitrary constant;
(b) cross-footing the scaled investments obtained in (a) to obtain an unscaled dummy;
(c) scaling the unscaled dummy to the same constant used to scale the investments in (a) to obtain a scaled dummy; and
(d) using as many scaled dummies as are required to achieve the same number of investments within all instances and the same number of instances within all aggregates of interest in the portfolio.

6. The process of claim 5, wherein the fundamentals are cash flows.

7. The process of claim 5, wherein the arbitrary constant is the mean of the fundamentals.
